(19) United States
(12) Patent Application Publication
(10) Pub. No.: US 2013/0304487 A1
(43) Pub. Date: Nov. 14, 2013

(54) COOPERATIVE MEDICAL SYSTEM

(71) Applicant: KONICA MINOLTA, INC., Tokyo (JP)

(72) Inventor: Naokazu KUWAYAMA, Tokyo (JP)

(73) Assignee: KONICA MINOLTA, INC., Tokyo (JP)

(21) Appl. No.: 13/886,127

(22) Filed: May 2, 2013

(30) Foreign Application Priority Data
May 10, 2012 (JP) 2012-108125

(51) Int. Cl. G06F 19/00

(52) U.S. Cl. CPC G06F 19/322
USPC 705/2

(57) ABSTRACT

Disclosed is a cooperative medical system including a data management server and terminal devices provided at medical facilities which are connected with the data management server to perform data communication therebetween. In the cooperative medical system, a first terminal device in the plurality of terminal devices includes a setting unit which establishes a setting between a second terminal device and a third terminal device to enable data communication therebetween, and the data management server stores medical information data which is sent from one of the second terminal device and the third terminal device in a data storage region allocated to a medical facility where the first terminal device is provided, and the data management server includes a data management unit which permits the medical information data stored in the data storage region to be read out from the other of the second terminal device and the third terminal device.

### BACKGROUND OF THE INVENTION

1. Field of the Invention

The present invention relates to a cooperative medical system.

2. Description of Related Art

In recent years, as medical techniques becoming diversified, cooperative medical care within community where multiple medical facilities including hospitals with specific functions, clinics and such like sharing medical information data and practicing examinations and medical treatments on patients in cooperation is becoming common. Specifically, cases where technical tasks such as image diagnosis, image analysis and such alike are outsourced are increasing.

Because medical information data is patients' personal information, such data needs to be protected from leakage. If a cooperative relation is established between medical facilities without thoroughly checking who you are cooperating with when establishing such relation, there will be high risk of medical information data leakage.

For example, in order to improve the security system to protect the medical information data shared among a cooperative medical system, there is suggested a technique of sending a confirmation request to a cooperation requester terminal from a data management server to confirm the user registration information of the healthcare professional at the cooperator side; and then, assigning a user ID to the healthcare professional at the cooperator side when a confirmed notice is received from the cooperation requester terminal (see JP 2011-181025.

However, in the above conventional technique, it is troublesome because authentication/authorization to confirm a user at the medical facilities need to take place when establishing a cooperative relation.

### SUMMARY OF THE INVENTION

The present invention was made in view of the above problems, and an object of the present invention is to reduce the burden at the time of establishing a cooperative relation between medical facilities.

In order to solve the above problem, according to one aspect of the present invention a cooperative medical system includes a data management server including a storage unit in which medical information data is stored and terminal devices provided at a plurality of medical facilities, respectively, which are connected with the data management server so as to perform data communication therebetween and a first terminal device in the plurality of terminal devices includes a setting unit which establishes a setting between a second terminal device and a third terminal device, excluding the first terminal device, to enable data communication therebetween, and the data management server stores medical information data which is sent from one of the second terminal device and the third terminal device in a data storage region in the storage unit allocated to a medical facility where the first terminal device is provided, and the data management server includes a data management unit which permits the medical information data stored in the data storage region to be read out from the other of the second terminal device and the third terminal device.

According the this aspect of the present invention, the burden at the time of establishing cooperative relations between medical facilities can be reduced.

Preferably, the medical information data includes data of a medical image, an examination result or an image interpretation result.

### BRIEF DESCRIPTION OF THE DRAWINGS

The present invention will become fully understood from the detailed description given hereinbelow and the appended drawings which are given by way of illustration only, and thus are not intended as a definition of the limits of the present invention, and wherein:

FIG. 1 is a diagram showing a system configuration of a cooperative medical system;

FIG. 2 is a block diagram showing a functional configuration of a data management server;

FIG. 3 is a data configuration example of a facility management table;

FIG. 4 is a data configuration example of a cooperative relation establishment table;

FIG. 5 is a data configuration example of a cooperation history table;

FIG. 6 is a block diagram showing a functional configuration of a terminal device;

FIG. 7 is a ladder chart showing a cooperative relation establishing process;

FIG. 8 is an example of an operation screen to be displayed on a terminal device at a community core hospital;

FIG. 9 is an example of a cooperative relation establishing screen to be displayed on a terminal device at a community core hospital;

FIG. 10 is an example of a cooperative relation establishing screen to be displayed on a terminal device in a community core hospital;

FIG. 11A is a case example where a cooperative relation is established between only the community core hospital X and the clinics A and B;

FIG. 11B is a case example where a cooperative relations are established between the community core hospitals X and Y and the clinics A and B;

FIG. 12 is a ladder chart showing cooperative medical processing; and

FIG. 13 is an example of a community cooperation screen to be displayed on a terminal device at a clinic.

### DESCRIPTION OF THE PREFERRED EMBODIMENTS

### [Configuration of Cooperative Medical System]

Hereinafter, an embodiment of a cooperative medical system according to the present invention will be described with reference to the drawings.

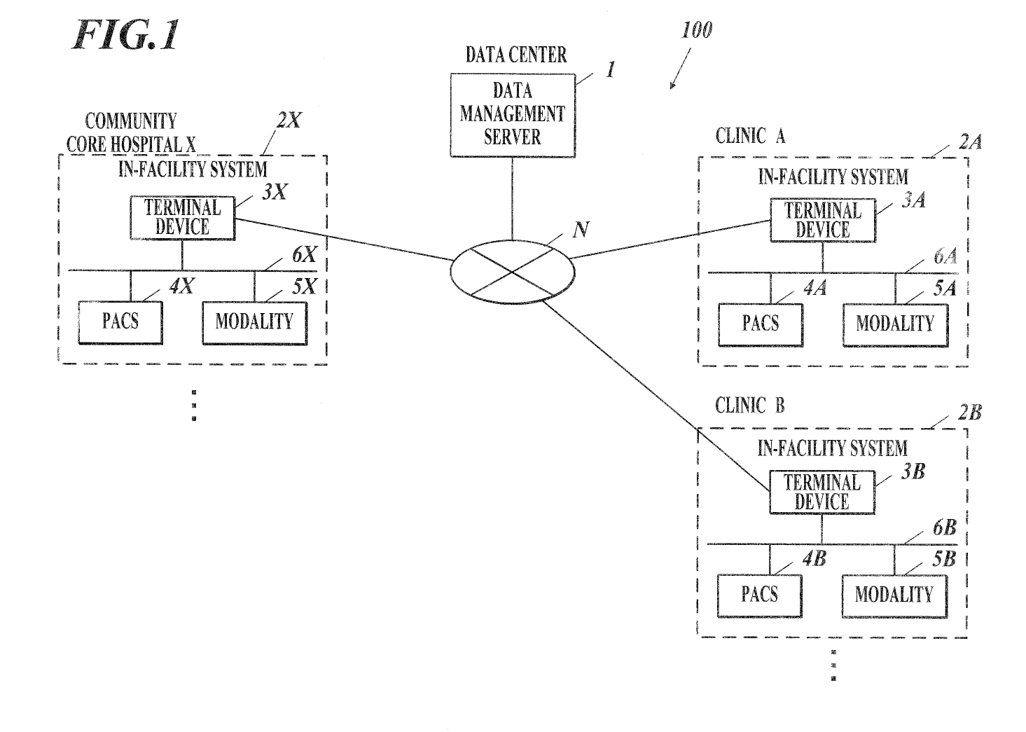

FIG. 1 shows a system configuration of the cooperative medical system 100.

As shown in FIG. 1, the cooperative medical system 100 includes a data management server 1 which is set at the data center of a community, an in-facility system 2A which is at the clinic A, an in-facility system 2B which is set at the clinic B, an in-facility system 2X which is set at the community core hospital X and the like. The data management server 1, the in-facility system 2A, the in-facility system 2B, the in-facility system 2X and the like are connected so that data communication can be performed with each other through a communication network N such as the internet.

Here, the number of in-facility systems 2A, 2B, 2X and more constituting the cooperative medical system 100 and the number of devices within each of the in-facility systems 2A, 2E, 2X and more are not specifically limited.

The data management server 1 accumulates and manages medical information data generated in medical facilities (such as the clinic A, clinic B and community core hospital X) Further, the data management server 1 provides cooperative medical services between medical facilities. The data management server 1 receives requests from the in-facility systems 2A, 2B, 2X . . . to perform examinations and image (radiological) interpretations in another in-facility system and manages image data of medical images (hereinafter referred to as medical image data), data of examination results (hereinafter referred to as examination result data), data of image interpretation results (hereinafter called image interpretation reports) and the like.

The in-facility system 2A is configured by a terminal device 3A, a PACS (Picture Archiving and Communication System) 4A, a modality 5A and the like being connected so that data communication can be performed with each other through an in-facility network 6A such as LAN (Local Area Network). The terminal device 3A is connected with the data management server 1 through the communication network. N so that data communication can be performed.

The in-facility system 2B is configured by a terminal device 3B, a PACS 4B, a modality 5B and the like being connected so that data communication can be performed with each other through an in-facility network 6B such as LAN. The terminal device 3B is connected with the data management server 1 through the communication network N so that data communication can be performed.

The in-facility system 2X is configured by a terminal device 3X, a PACS 4X, a modality 5X and the like being connected so that data communication can be performed with each other through an in-facility network 6X such as LAN. The terminal device 3X is connected with the data management server 1 through the communication network N so that data communication can be performed.

The terminal device 3A is a computer used by a healthcare professional at the clinic A to perform medical cooperation with a healthcare professional at another medical facility. The terminal device 3A is used to access the data management server 1 through the communication network N, to send medical information data to the data management server 1 and to review the medical information data stored in the data management server 1.

Similarly, the terminal device 3B is a computer used by a healthcare professional at the clinic B to perform medical cooperation with a healthcare professional at another medical facility.

The terminal device 3X is a computer used by a healthcare professional at the community core hospital X to perform medical cooperation with a healthcare professional at another medical facility and to establish a cooperative relation with other medical facilities. The terminal device 3X is used to access the data management server 1 through the communication network N, to send medical information data and establishment information on cooperative relations to the data management server 1 and to review the medical information data stored in the data management server 1.

Each of the PACS 4A, 4B, 4X . . . is a computer including a control unit, a RAM (Random Access Memory), a communication unit, an operating unit, a display unit, a storage unit and the like. The PACS 4A, 4B, 4X . . . are in-facility servers which mainly store the medical image data and the like generated by in-facility modalities 5A, 5B, 5X . . . in their storage units by associating the medical image data and the like with patient information.

The modalities 5A, 5B, 5X . . . pick up images of human body and generate digital data of the picked up images (medical images). For example, CR (Computed Radiography), FPD (Flat Panel Detector), CT (Computed Tomography), MRI (Magnetic Resonance Imaging), a reading device exclusive to cassette, a film digitizer and the like can be applied as the modalities.

### [Configuration of Data Management Server]

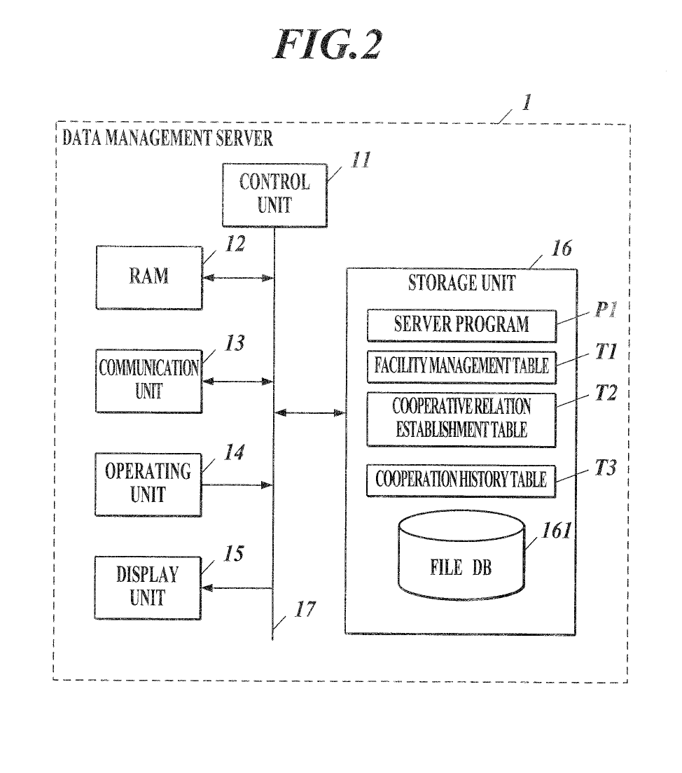

FIG. 2 shows a functional configuration of the data management server 1.

As shown in FIG. 2, the data management server 1 includes a control unit 11, a RAM 12, a communication unit 13, an operating unit 14, a display unit 15, a storage unit 16 and the like and they are connected to each other through a bus 17.

The control unit 11 includes a CPU (Central Processing Unit) and the like and integrally controls the processing operations of the parts in the data management server 1. The control unit 11 reads various types of programs stored in the storage unit 16 and develops the programs in the RAM 12 to execute various types of processes in cooperation with the programs.

In the RAM 12, there are formed work areas to temporarily store various types of programs which are read out from the storage unit 16 in the various types of processes which are executed and controlled by the control unit 11, and data and parameters which are input or output in the various types of processes which are executed and controlled by the control unit 11.

The communication unit 13 includes a network interface and the like and performs sending and receiving of data with an external device which is connected via the communication network N. In particular, the communication unit 13 receives establishment information on cooperative relations sent from the terminal devices 3X and others and medical information data sent from the terminal devices 3A, 3B, 3X . . . .

The operating unit 14 includes a key board having a cursor key, numerical input keys, various types of function keys and the like and a pointing device such as a mouse. The operating unit 14 output operation signals input by key operations performed on the key board and mouse operations to the control unit 11.

The display unit 15 includes a monitor such as LCD (Liquid Crystal Display) and displays various types of screens according to instructions of display signals input from the control unit 11.

The storage unit 16 includes a HDD (Hard Disk Drive), a semiconductor non-volatile memory or the like. In the storage unit 16, parameters and data required for executing the various types of programs are store in addition to the various types of programs which are to be executed by the control unit 11. In particular, in the storage unit 16, a server program P1, a facility management table T1, a cooperative relation establishment table T2, a cooperation history table T3, a file DB 161 and the like are stored,

The server program P1 is a program for executing an establishing process of cooperative relation and a process for providing cooperative medical services in the data management server 1.

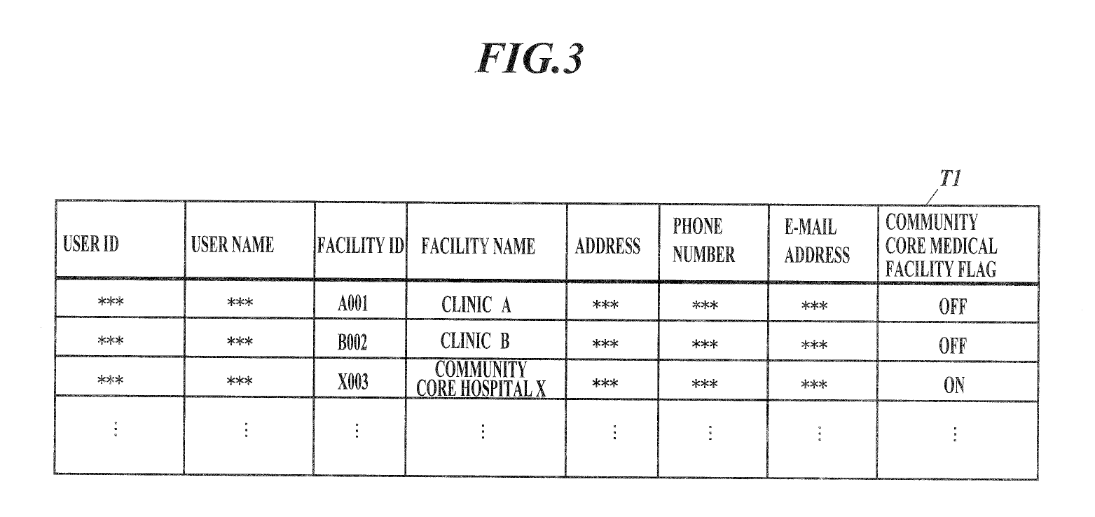

FIG. 3 shows a data configuration example of the facility management table T1. The facility management table Ti stores information relating to the users at each of the medical facilities in the cooperative medical system 100. In the facility management table T1, “user ID”, “user name”, “facility ID”, “facility name”, “address”, “phone number”, “e-mail address”, “community core medical facility flag” and the like are stored by being associated to each other.

The “user ID” is identification information for identifying a user,

The “user name” is a name assigned to a user.

The “facility ID” is identification information for identifying a medical facility.

The “facility name” is a name of a medical facility.

The “address” and “phone number” are address and phone number of a medical facility.

The “e-mail address” is an e-mail address of a user.

The “community core medical facility flag” is a flag indicating whether a medical facility is the community core hospital or not. When a. given medical facility is the community core hospital, the flag will be “ON”; and when a given medical facility is not the community core hospital, the flag will be “OFF”. The community core hospitals are the large scale medical facilities comparing to a general clinics and infirmaries.

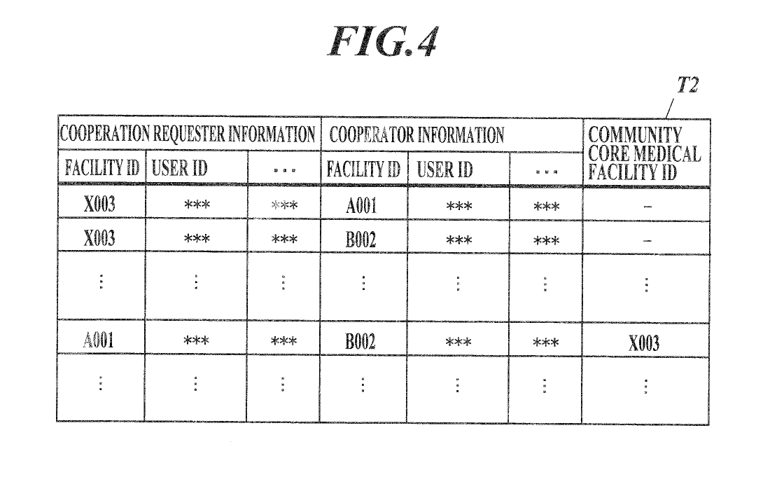

FIG. 4 shows a data configuration example of the cooperative relation establishment table T2. The cooperative relation establishment, table T2 stores information relating to the cooperative relations between the medical facilities in the cooperative medical system 100. In the cooperative relation establishment table T2, “cooperation requester information”, “cooperator information”, “community core medical facility ID” and the like are stored so as to be associated with each other.

The “cooperation request information” includes the “facility ID” and “user ID” of a medical facility which is the requester of cooperation.

The “cooperator information” includes the “facility ID” and “user ID” of a medical facility which is the cooperator who responds to the request.

In the “community core medical facility ID”, the facility ID of the community core hospital is stored when the relevant cooperative relation involves the community core hospital. The “community core medical facility ID” will be left blank when the relevant cooperative relation does not involve the community core hospital.

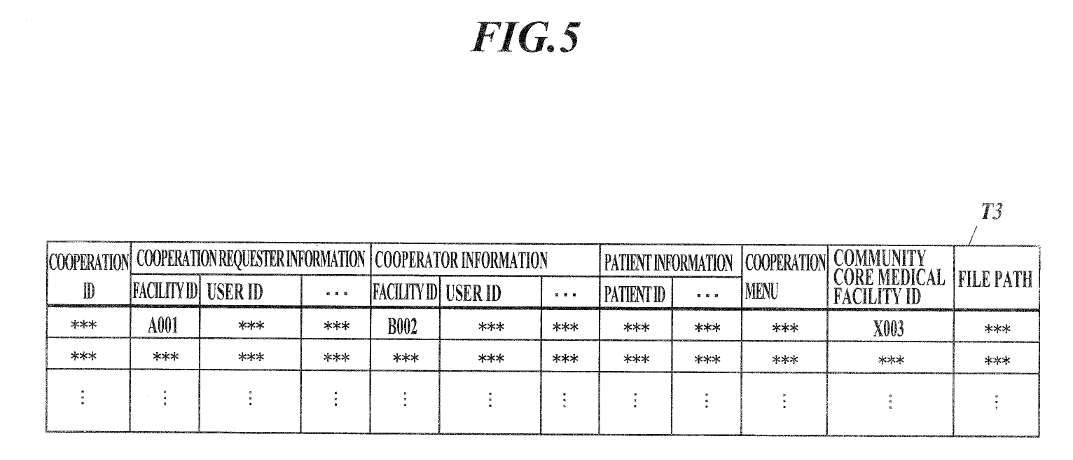

FIG. 5 shows a data configuration example of the cooperation history table T3. The cooperation history table T3 stores information relating to the cooperative medical services performed among the medical facilities in the cooperative medical system 100. In the cooperation history table T3, “cooperation. ID”, “cooperation requester information”, “cooperator information”, “patient information”, “cooperation menu”, “community core medical facility ID”, “file path” and the like are stored by being associated with each other.

The “cooperation. ID” is data identification information which is assigned every time the cooperative medical service is used.

The “patient information is information relating to a patient who is subject to the cooperative medical service and includes the patient ID and the like.

The “cooperation menu” indicates the type (category) of a cooperation selected by a user who is the cooperation requester. As for cooperation menu, for example, patient referral, examination request, image interpretation request, consultation and the like can be included.

In the “community core medical facility ID”, the facility ID of the community core hospital is to be stored when the relevant cooperative relation involves the community core hospital. When the relevant cooperative relation does not involve the community core hospital, the “community core medical facility ID” will remain blank.

The “file pass” is information indicating the storage location of a medical information data file in the file DB 161.

The file DB 161 is a data base for storing medical information data. Medical information data includes medical image data, examination result data, image interpretation report and the like. In the file DB 161, a usable data storage region is allocated to each medical facility in the cooperative medical system 100, and each medical facility and the data storage region allocated to the medical facility are associated to each other to be stored in the storage unit 16, The data storage regions may be indicated in terms of usable data storage locations or as usable data capacities. When the cooperative relation involves the community core hospital, the medical information data which is sent and received between the cooperation requester and the cooperator is to be stored in the data storage region allocated to the community core hospital in the file DB 161. When the cooperative relation does not involve the community core hospital, the medical information data which is sent and received between the cooperation requester and the cooperator is to be stored in the data storage region allocated to the cooperation requester in the file DB 161.

When the control unit 11 receives the establishment. information on the cooperative relation (including information indicating the second terminal device and the third terminal device excluding the first terminal device) which is sent from the first terminal device (the terminal device 3A at the community core hospital X or the like) among a plurality of terminal devices according to the server program P1 stored in the storage unit 16, the control unit 11 uses the data storage region in the storage unit 16 allocated to the medical facility where the first terminal device is provided to enable data communication between the second terminal device and the third terminal device.

The control unit 11 makes the medical information data sent from one of the second terminal device and the third terminal device be stored in the data storage region in the storage unit 16 allocated for the medical facility where the first terminal device is provided. Further, the control unit 11 permits the medical information data stored in the data storage region to be read out from the other of the second terminal device and the third terminal device. That is, the control unit 11 functions as a data management unit.

### [Configuration of Terminal Device]

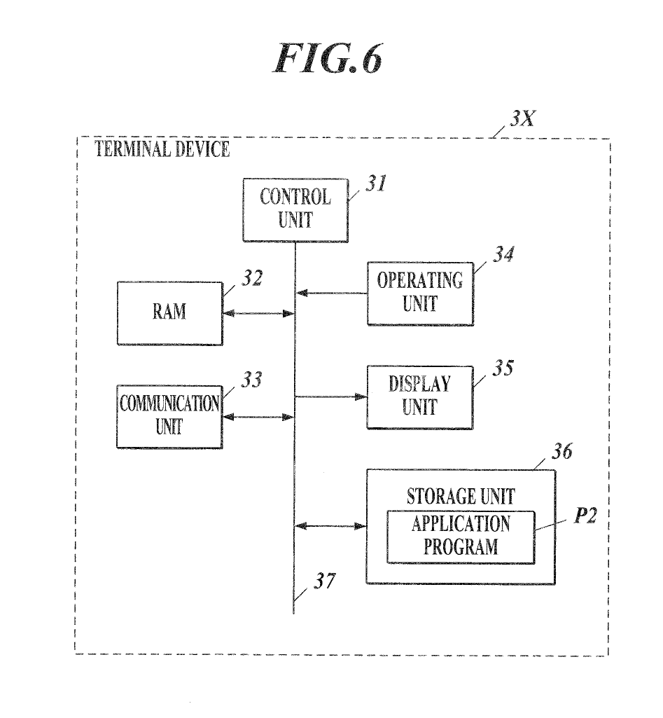

FIG. 6 shows a functional configuration of the terminal device 3X at the community core hospital X.

As shown in FIG. 6, the terminal device 3X includes a control unit 31, a RAM 32, a communication unit 33, an operating unit 34, a display unit 35, a storage unit 36 and the like, and they are connected to each other through a bus 37 or the like.

The control unit 31 includes a CPU and the like and integrally controls the process operations of the parts in the terminal device 32. The control unit 31 reads out and develops various types of programs stored in the storage unit 36 in the RAM 32 and executes the various processes in cooperation with the programs.

In the RAM 32, there are formed work areas to temporarily store various types of programs which are read out from the storage unit 36 in the various types of processes which are executed and controlled by the control unit 31, and data and parameters which are input or output in the various types of processes which are executed and controlled by the control unit 31.

The communication unit 33 includes a network interface and the like and performs sending and receiving of data with an external device which is connected via the communication network N or an in-facility network 6X. In particular, the communication unit 33 sends the establishment information on the cooperative relation set by the operating unit 34 to the data management server 1.

The operating unit 34 includes a key board having a cursor key, numerical input keys, various types of function keys and the like and a pointing device such as a mouse. The operating unit 34 outputs operation signals that are input by key operations performed on the key board and mouse operations to the control unit 31. For example, the operating unit 34 is used when a setting which enables data communication between the second terminal device and the third terminal device in the plurality of terminal, devices excluding the terminal device 3X is to be set, that is, when establishing a cooperative relation between the second terminal device and the third terminal device.

The display unit 35 includes a monitor such as LCD and displays various types of screens according to instructions of display signals input from the control unit 31.

The storage unit 36 includes a HDD, a semiconductor nonvolatile memory or the like. In the storage unit 36, parameters and data required for executing the various types of programs are stored in addition to the various types of programs to be executed by the control unit 31. In particular, the application program P2 and the like are stored in the storage unit 36.

The application program P2 is a program for executing the establishing process of cooperative relation, a process for using the cooperative medical service and the like.

Based on the operation of the operating unit 34, the control unit 31 establishes a setting enabling data communication between the second terminal device and the third terminal device in the plurality of terminal devices excluding the terminal device 3X by using the data storage region in the storage unit 16 allocated to the community core hospital X in the data management server 1. That is, the control unit 31 functions as a setting unit.

The configurations of the terminal devices 3A and 3E are similar to that of the terminal device 3X. Therefore, FIG. 6 is referred to and they will not be shown as drawings, and their descriptions are omitted.

### [Cooperative Relation Establishing Process]

Next, operations according to the embodiment will be described.

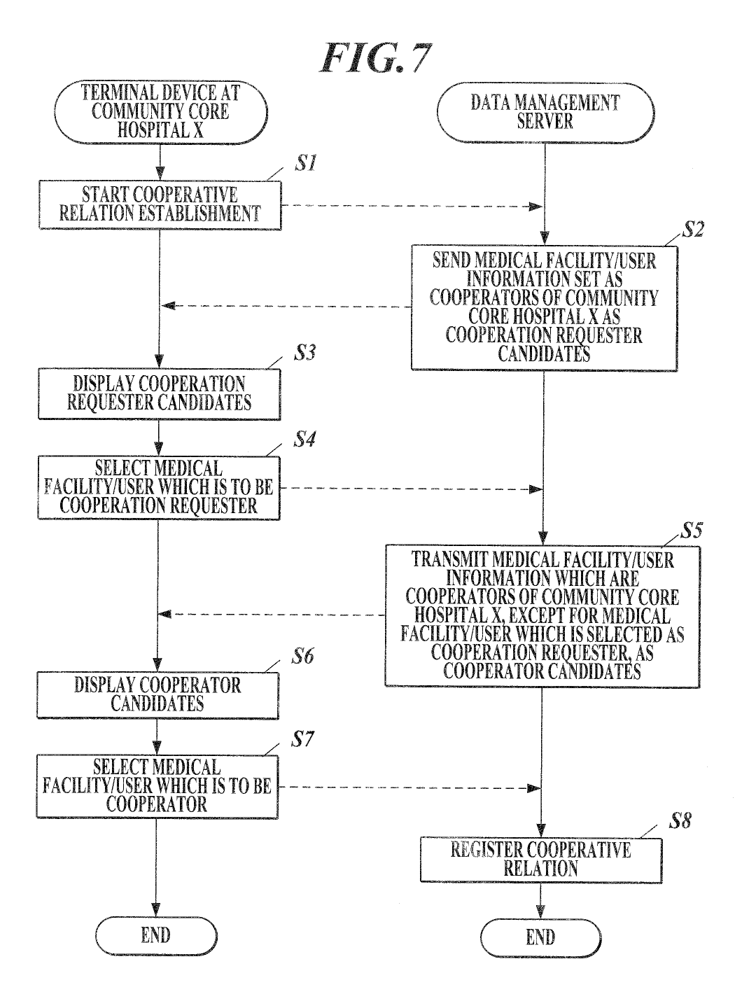

FIG. 7 is a ladder chart showing the cooperative relation establishing process carried out by the terminal device 3X at the community core hospital X and the data management server 1. The cooperative relation establishing process is a process which is performed, for example, when a healthcare professional at the clinic A requests the community core hospital X by a phone call or the like to establish a cooperative relation with a healthcare professional at the clinic B. Here, the operation in the data management server 1 is executed by the control unit 11 and the server program P1 cooperating with each other and the operation in the terminal device 3X is executed by the control unit 31 and the application program P2 cooperating with each other.

First, in the terminal device 3X at the community core hospital X, establishing of a cooperative relation is started by an operation performed on the operating unit 34 (step S1).

For example, when a login operation to the cooperative medical system 100 is performed in the terminal device 3X, the user ID of an operator of the terminal device 3X and the like are sent to the data management server 1 by the control unit 31 via the communication unit

In the data management server 1, the user ID and the like from the terminal device 3X are received by the communication unit 13. Then, when the facility management table T1 stored in the storage unit 16 is referred to and confirmed that the community core medical facility flag of the record corresponding to the received user ID is ON by the control unit 11, the terminal device 3X is provided with the operation screen for establishing the cooperative relation.

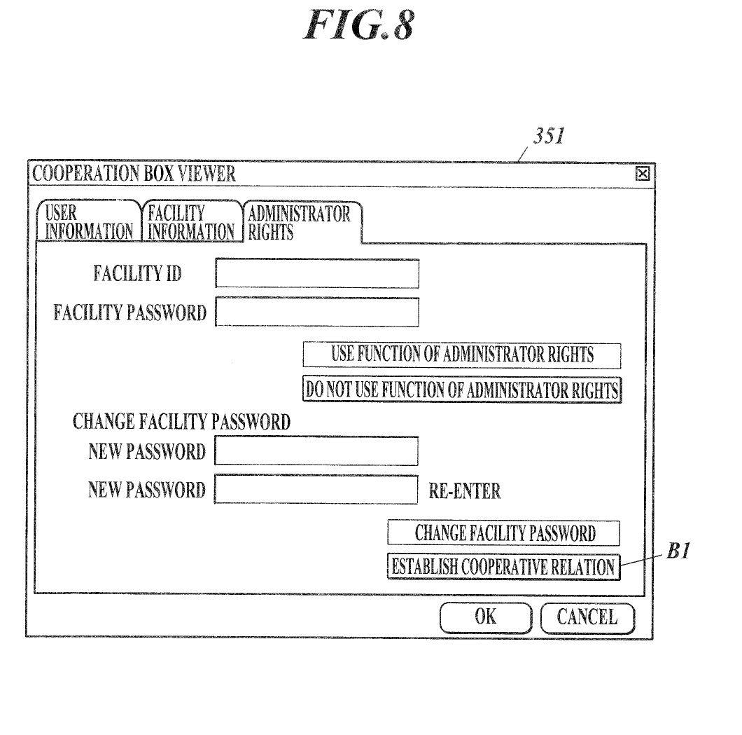

FIG. 8 shows an example of the operation screen 351 to be displayed in the display unit 35 of the terminal device 3X at the community core hospital X. When the “establish cooperative relation” button B1 in the operation screen 351 is pushed, the cooperative relation establishing is started.

Next, in the data management server 1, medical facilities or users set as cooperators of the community core hospital X are extracted as cooperation. requester candidates and information on the extracted cooperation requester candidates is sent to the terminal device 3X via the communication unit 13 by the control unit 11 (step S2).

In particular, the cooperative relation establishment table T2 stored in the storage unit 16 is referred to and the medical facilities corresponding to the facility IDs in the cooperator information of the records where the facility IDs in the cooperation requester information are “X003 (community core hospital X)” or the users corresponding to the user IDs in the cooperator information of the records where the user IDs in the cooperation requester information are “X003 (community core hospital X)” are extracted by the control unit 11. The fact that the medical facility or the user is set as the cooperator of the community core hospital X means that the medical facility or the user gave permission to the community core hospital X. to establish cooperative relations with other facilities which are set as the cooperators of the community core hospital X.

In the terminal device 3X, information of the cooperation requester candidates is received by the communication unit 33 and the cooperation requester candidates are displayed by the control unit 31 (step S3).

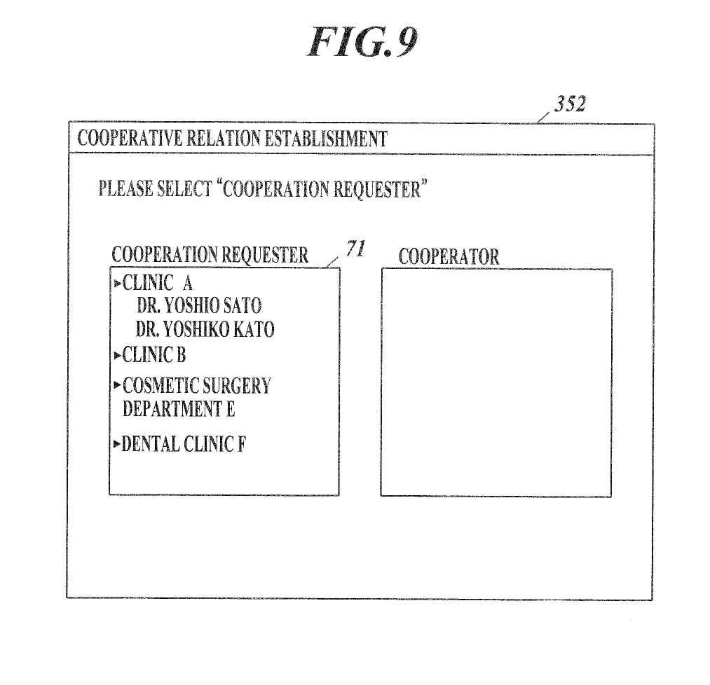

FIG. 9 shows an example of the cooperative relation establishment screen 352 to be displayed in the display unit 35 of the terminal device 3X at the community core hospital X. In the cooperation requester display region 71 in the cooperative relation, establishment screen 352, the medical facilities and users extracted as the cooperation requester candidates are displayed. The cooperation requester can be selected by a medical facility unit or by a. user unit.

The operator of the terminal device 3X selects a medical facility or a user which is the cooperation requester among the cooperation requester candidates displayed in the display unit 35 by operating the operating unit 34 (step 4). That is, one of the terminal devices between which data communication is to be enabled by the cooperative relation establishment, is set. The information indicating the medical facility or the user which is the selected cooperation requester is sent to the data management server 1 by the control unit 31 via the communication unit

In the data management server 1, the information indicating the medical facility or the user which is the cooperation requester selected in the terminal device 3X is received by the communication unit 13, The information indicating the medical facility or the user which is the cooperation requester which is received is stored in the RAM 12 by the control unit 11.

Next, by the control unit 11, medical facilities or users among the medical facilities and users set as the cooperators of the community core hospital X excluding the medical facility or user selected as the cooperation requester in step S4 are extracted as the cooperator candidates and information on the extracted cooperators is sent to the terminal device 3X via the communication unit 13 (step S5).

In particular, by the control unit 11, the cooperative relation establishment table T2 stored in the storage unit 16 is referred to and the medical facilities corresponding to the facility IDs in the cooperator information of the records where the facility IDs in the cooperation requester information are “X003 (community core hospital X)” or the users corresponding to the user IDs in the cooperator information of the records where the user IDs in the cooperation requester information are “X003 (community core hospital X)” are extracted.

In the terminal device 3X, the communication unit 33 receives the information on the cooperator candidates is received and the control unit 31 displays the cooperator candidates in the display unit (step S6).

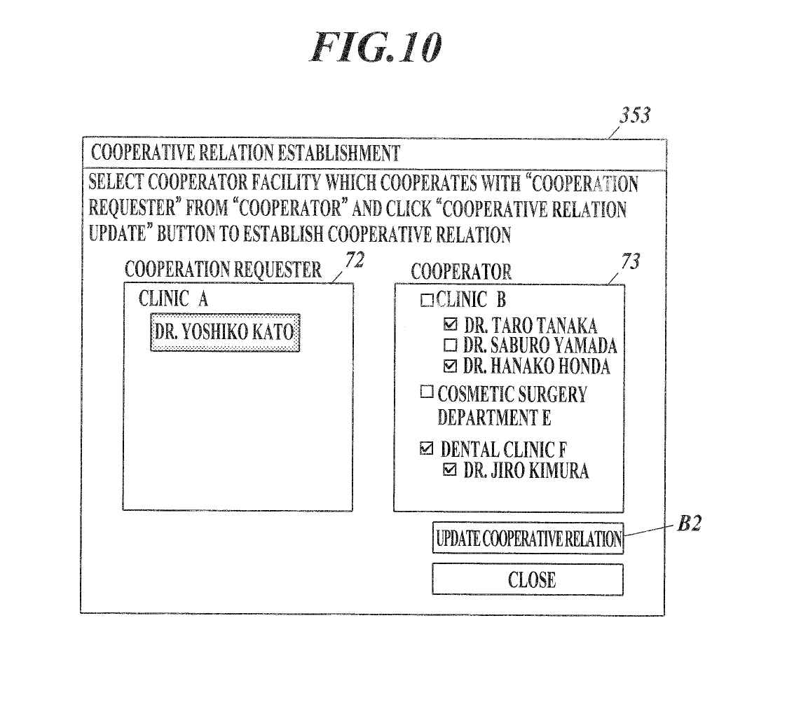

FIG. 10 shows an example of the cooperative relation establishment screen 353 to be displayed in the display unit 35 of the terminal device 3X at the community core hospital X In the cooperation requester display region 72 in the cooperative relation establishment screen 353, the medical facility or user selected as the cooperation requester is displayed. Here, “Dr. Yoshiko Kato” at “clinic A” is selected as the user of the cooperation requester. In the cooperator display region. 73, the medical facilities and users extracted as the cooperator candidates of “Dr. Yoshiko Kato” at “clinic A” are displayed_{—} The cooperator can also be selected in a medical facility unit or in a user unit. Here, as for the cooperator, a plurality of medical facilities and users can be selected at the same time.

The operator of the terminal device 3X selects a medical facility or a user which is the cooperator from the cooperator candidates displayed in the display unit 35 by performing an operation on the operating unit 34 (step S7). That is, the other of the terminal devices between which data communication is to be enabled by the establishment of the cooperative relation is set.

In the cooperator display region 73 in the cooperative relation establishment screen 353, a check box is provided for every medical facility and user. When the check box corresponding to a given medical facility is checked in the cooperator display region 73, the check boxes corresponding to all of the users who belong to the given medical facility are to be checked. Further, when the check box corresponding to the given medical facility is cleared, the check boxes corresponding to all of the users who belong to the given medical facility are to be cleared. When at least one check box corresponding to a user who belongs to the given medical facility is cleared in a state where the check box corresponding to the given medical facility is checked, the check box corresponding to the given medical facility is to be cleared.

When a medical facility or a user which is the cooperator is selected by performing an operation on the operating unit 34 in the cooperator display region 73 in the cooperative relation establishment screen 353 and the “cooperative relation update” button B2 is pushed, the control unit 31 sends the information indicating the selected medical facility or user which is the cooperator to the data management server 1 via the communication unit 33.

For example, in a case where “clinic A” is selected as the cooperation requester and “clinic B” is selected as the cooperator, the users who belong to the clinic A and the users who belong to the clinic B are to form cooperative relations with each other.

In a case where “Dr: Yoshiko Kato” at “clinic A” is selected as the cooperation requester and “clinic B” is selected as the cooperator, Dr. Yoshiko Kato who belongs to the clinic A and the users who belong to the clinic B are to form cooperative relations with each other.

In a case where “clinic A” is selected as the cooperation requester and “Dr. Taro Tanaka” at “clinic B” is selected as the cooperator, the users who belong to the clinic A and Dr. Taro Tanaka who belongs to the clinic B are to form cooperative relations with each other.

In a case where “Dr. Yoshiko Kato” at “clinic A” is selected as the cooperation requester and “Dr. Taro Tanaka” at “clinic B” is selected as the cooperator, Dr. Yoshiko Kato who belongs to the clinic A. and Dr. Taro Tanaka who belongs to the clinic B are to form a cooperative relation.

In the data management server 1, the communication unit 13 receives the information indicating the medical facility or user which is the cooperator selected in the terminal device 3X. The control unit 11 stores the received information indicating the medical facility or user which is the cooperator in the RAM 12.

Next, in the data management server 1, the control unit 11 registers the cooperative relation(s) (step S8).

In particular, by the control unit 11, the information indicating the medical facility or user which is the cooperation requester selected in step S4 is stored in the cooperation requester information in the cooperative relation establishment table T2, the information indicating the medical facility or user which is the cooperator selected in step S7 is stored in the cooperator information in the cooperative relation establishment table T2, and the facility ID of the community core hospital X is stored in the community core medical facility ID in the cooperative relation establishment table T2.

In such way, data communication can be enabled between the terminal device of cooperation requester and the terminal device of cooperator by using the data storage region in the storage unit 16 allocated to the community core hospital X.

In a case where both clinics A and B are set as the cooperators of each of the community core hospitals X and Y, a cooperative relation between the clinic A and the clinic B can be established at each of the community core hospitals X and Y.

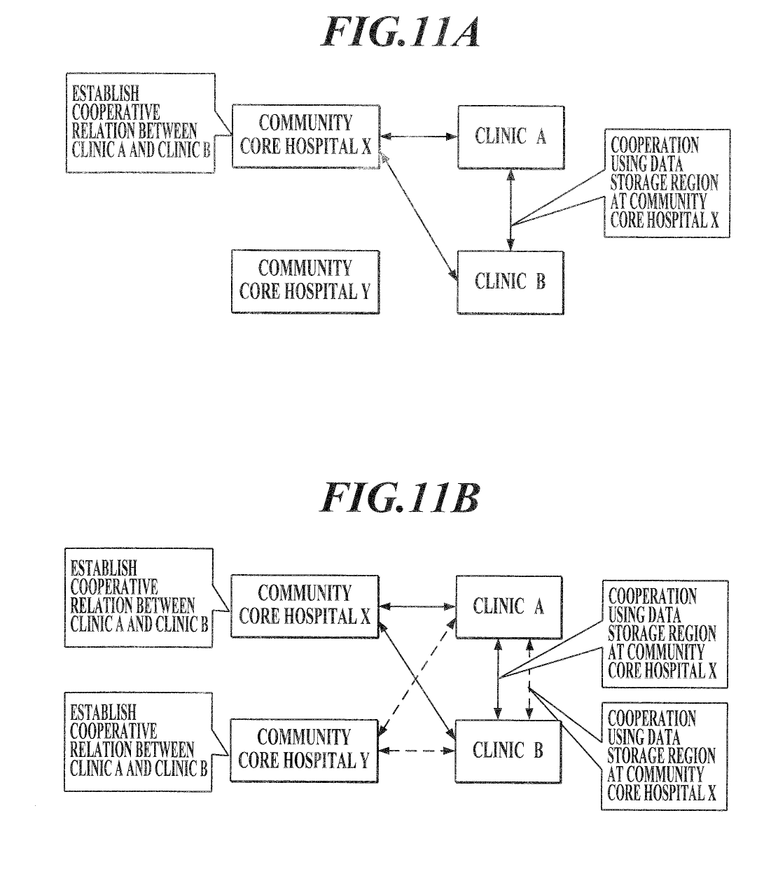

As shown in FIG. 11A, when a cooperative relation between the clinic A and the clinic B is established only at the community core hospital X, data communication is performed by using the data storage region in the data management server 1 allocated to the community core hospital X when sending medical information data to the clinic B from the clinic A. The data storage region in the data management server 1 allocated to the community core hospital Y cannot be used.

As shown in FIG. 11B, when cooperation relations between the clinic A and the clinic. B are established at both of the community core hospitals X and Y, data communication can be performed by using the data storage region in the data management server 1 allocated to the community core hospital X or the data storage region in the data management server 1 allocated to the community core hospital Y when sending medical information data to the clinic B from the clinic A. Which data storage region is to be used can be selected at the clinic A when sending the medical information data.

### [Cooperative Medical Process]

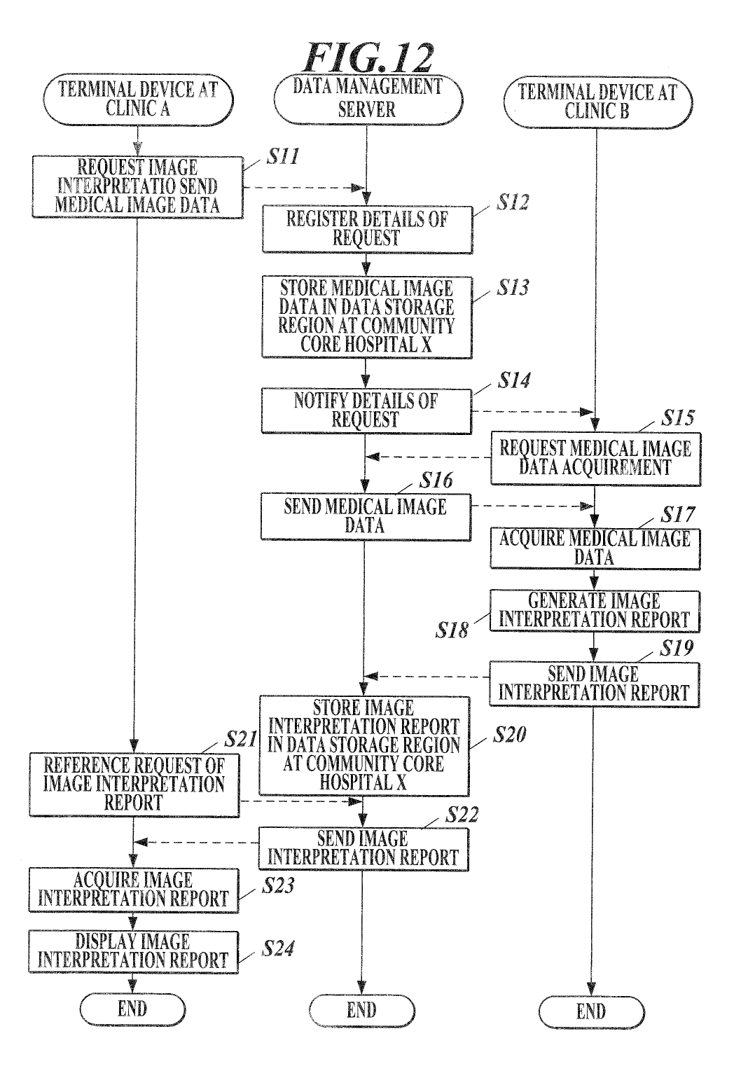

FIG. 12 is a ladder chart showing the cooperative medical process performed between the terminal devices 3A and 3B and the data management server 1. Here, a description will be made by taking the case where the cooperative relation between the terminal device 3A at the clinic A and the terminal device 3B at the clinic B is already established with the terminal device 3X at the community core hospital X as an example. The operation in the data management server 1 is executed by the control unit 11 and the server program P1 cooperating with each other and the operation in each of the terminal devices 3A and 3B is executed by the control unit 31 and the application program P2 cooperating with each other.

FIG. 12 shows an example where image interpretation of medical image data obtained by picking up an image of a patient is requested.

First, in the terminal device 3A at the clinic A, an image interpretation request is input and the medical image data which is to be subject to image interpretation is selected by performing an operation on the operating unit 34. Then, the control unit 31 sends the image interpretation request and the medical image data to the data management server 1 via the communication unit 33 (step S11).

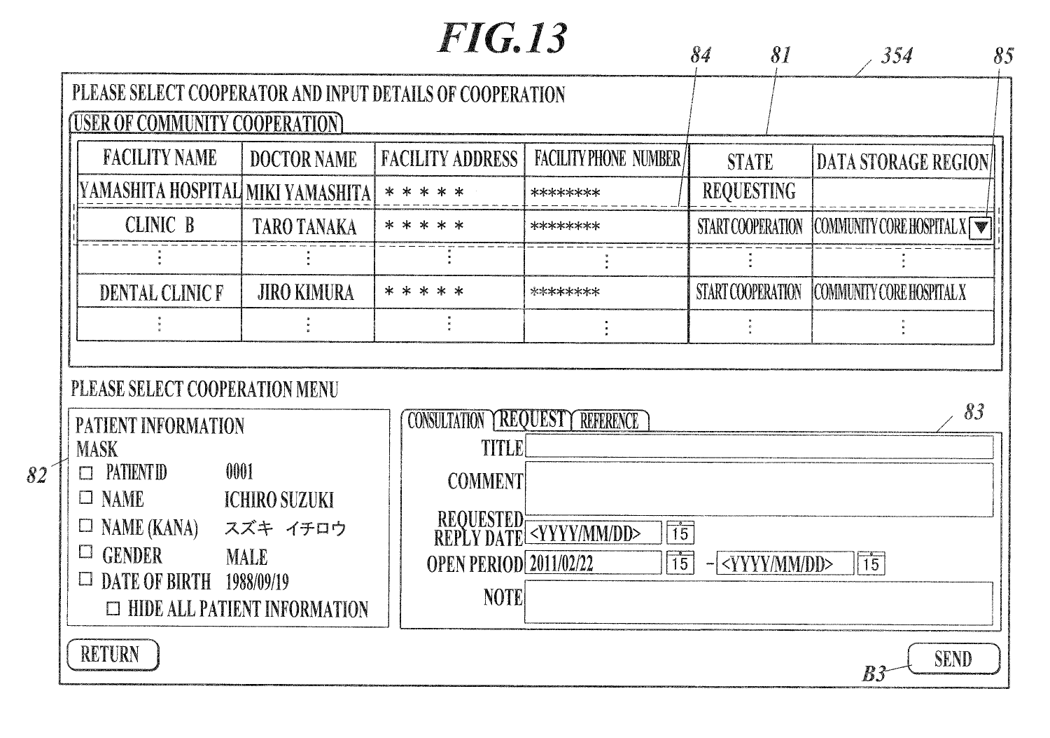

FIG. 13 shows an example of the community cooperation screen 354 to be displayed in the display unit 35 of the terminal device 3A. The community cooperation screen 354 includes a cooperator selecting region 81, a patient information display region 82 and a detail of cooperation input region 83.

In the cooperator selecting region 81, the medical facilities and users with which a given user at the clinic A established cooperative relations and the medical facilities and users who the given user at the clinic A is in process of establishing cooperative relations are displayed. For example, in a case where the cooperative relations between a given user at the clinic A and “Dr. Taro Tanaka” at “clinic B” are established at a plurality of community core hospitals X and Y, a pull-down menu 85 is provided at the “data storage region” column in the selecting region 84 of “Dr. Taro Tanaka” at “clinic B” and either of the community core hospitals X and Y which relays medical information data can be selected.

In the patient information display region 82, the patient information of the patient who is subject to the cooperation is displayed.

In the details of cooperation input region 83, tabs are provided for the types of cooperation (consultation, request, referral and the like) and the details of the cooperation are input.

When the “send” button B3 is pushed in the community cooperation screen 354, the control unit 31 sends the cooperation request (consultation, examination request, image interpretation request, referral and the like) to the data management server 1 via the communication unit 33. The cooperation request includes “cooperation requester information”, “cooperator information”, “patient information”, “cooperation menu”, “community core medical facility ID” and the like. In a case where the cooperation request includes medical information data, the control unit 31 sends the medical information data to the data management server 1 via the communication unit 33.

In the data management server 1, the communication unit 13 receives the image interpretation request and the medical image data and the control unit 11 registers the details of the request in the cooperation history table T3 in the storage unit 16 (step S12). In particular, by the control unit 11, the cooperation ID which is newly issued is stored in the cooperation ID in the cooperation history table T3, information relating to the clinic A and the operator of the terminal device 3A is stored in the cooperation requester information in the cooperation history table T3, information relating to the clinic B and the healthcare professional selected in the cooperator selecting region 81 is stored in the cooperator information in the cooperation history table T3, the patient information on the subject patient displayed in the patient information display region 82 is stored in the patient information in the cooperation history table T3, the type of cooperation corresponding to the tab selected in the details of cooperation input region 83 is stored in the cooperation menu in the cooperation history table T3, and the facility ID of the community core hospital corresponding to the data storage region to be used in data communication between the cooperation requester and the cooperator is stored in the community core medical facility ID in the cooperation history table T3.

Further, the control unit 11 stores the medical image data in the data storage region in the file DB 161 in the storage unit 16 allocated to the community core hospital X (step S13). Then, the control unit 11 stores the storage location of the medical image data in the “file path” in the cooperation history table T3.

Next, the control unit 11 sends the details of the request to the terminal device 3B at the clinic B via the communication unit 13 (step S14).

In the terminal device 3B at the clinic B, the control unit 31 sends the acquirement request for the medical image data to the data management server 1 via the communication unit 33 on the basis of an operation performed on the operating unit 34 (step S15).

In the data management server 1, the communication unit 13 receives the acquirement request for the medical image data. Then, the control unit 11 reads out the quested medical image data from the data storage region at the community core hospital X and sends the medical image data to the terminal device 3B at the clinic B via the communication unit 13 (step S16).

In the terminal device 3B at the clinic B, the control unit 31 acquires the medical image data via the communication unit 33 (step S17). Then, the control unit 31 displays the medical image in the display unit 35 on the basis of the medical image data.

The operator of the terminal device 3B performs image interpretation of the medical image and inputs the image interpretation result by operating the operating unit 34. Then, the control unit 31 generates the image interpretation report on the basis of the details of the input (step S18) and sends the generated image interpretation repot to the data management server 1 via the communication unit 33 (step S19).

In the data management server 1, the communication unit 13 receives the image interpretation report and the control unit 11 stores the image interpretation report in the data storage region in the file DB 161 in the storage unit 16 allocated to the community core hospital X (step S20).

In the terminal device 3A at the clinic A, the control unit 31 sends the reference request of the image interpretation report to the data management server 1 via the communication unit 33 on the basis of an operation performed on the operating unit 34 (step S21).

In the data management server 1, the communication unit 13 receives the reference request of the image interpretation report. Then, the control unit 11 reads out the requested image interpretation report from the data storage region at the community core hospital X and sends the image interpretation report to the terminal device 3A at the clinic via the communication unit 13 (step S22).

In the terminal device 3A at the clinic A, the control unit 31 acquires the image interpretation report via the communication unit 33 (step S23). Then, the control unit 31 displays the image interpretation report in the display unit 35 (step S24).

As described above, according to the cooperative medical system 100 of the embodiment, for example, a setting to enable data communication between the terminal device 3A at the clinic A and the terminal device 3B at the clinic B can be established with the terminal device 3X at the community core hospital X. By performing the establishment of cooperative relations between medical facilities in a concentrating manner at the community core hospital X which knows the medical facilities very well, the burdens on the clinics A and B at the time of establishing the cooperative relations between the medical facilities can be reduced.

Moreover, because a plurality of cooperators can be set with respect to one cooperation requester when setting the cooperative relation with the terminal device 3X provided at the community core hospital X, cooperative relations between medical facilities can be established easily.

Here, description in the above embodiment is an example of the cooperative medical system according to the present invention and is not limitative in any way. The detail configurations and detail operations of the devices which constitute the system can be modified arbitrarily within the scope of the invention.

In the above description, an example where HDD or non-volatile memories are used as a computer readable medium which stores the programs for executing various types of processes is described. However, the present invention is not limited to such example. As for other computer readable medium, portable recording mediums such as a CD-ROM and the like can be applied. Further, a carrier wave can be applies as a medium for providing program data through a communication circuit.

The entire disclosure of Japanese Patent Application No. 2012-108125 filed on May 10, 2012 is incorporated herein by reference.

What is claimed is:

1. A cooperative medical system, comprising:
a data management server including a storage unit in which medical information data is stored; and
terminal devices respectively provided at a plurality of medical facilities which are connected with the data management server so as to perform data communication therebetween,
wherein
a first terminal device in the terminal devices includes a setting unit, which establishes a setting between a second terminal device and a third terminal device, excluding the first terminal device, to enable data communication therebetween, and
the data management server stores medical information data which sent from one of the second terminal device and the third terminal device in a data storage region in the storage unit allocated to a medical facility where the first terminal device is provided, and the data management server includes a data management unit which permits the medical information data stored in the data storage region to be read out from the other of the second terminal device and the third terminal device.

2. The cooperative medical system of claim 1, wherein the medical information data includes data of a medical image, an examination result or an image interpretation result.
